(19) United States
(12) Patent Application Publication
(10) Pub. No.: US 2012/0175363 A1
(43) Pub. Date: Jul. 12, 2012

(54) RF-BASED PYROLYTIC CLEANING

(75) Inventors: Amichai Ron, Jerusalem (IL); Elliad Silcoff, Tel Aviv (IL); Steven R. Rogers, D. N. Emek Sorek (IL)

(73) Assignee: Goji Limited

(21) Appl. No.: 13/340,759

(22) Filed: Dec. 30, 2011

Related U.S. Application Data
(60) Provisional application No. 61/428,406, filed on Dec. 30, 2010.

(51) Int. Cl. H05B 6/06

(52) U.S. Cl. 219/618

(57) ABSTRACT

The disclosure provides an apparatus that includes a casing having a wall and defining a cavity. The apparatus may also include a first RF feed that feeds RF energy to the cavity at a first frequency range. The apparatus may also include a controller, configured to control RF energy fed into the cavity via the first RF feed. In some embodiments, the wall comprises a frequency selective surface (FSS) that selectively absorbs RF energy at the first frequency range. The controller may control feeding RF energy to the cavity via the first RF to heat at least a portion of the wall to a temperature above a specified lower temperature threshold for a specified period of time.

### RELATED APPLICATIONS

The present application claims the benefit of priority from U.S. Provisional Patent Application No. 61/428,406 filed Dec. 30, 2010, the entire contents of which are incorporated herein by reference.

### TECHNICAL FIELD

The presently disclosed embodiments relate to heating with electromagnetic (EM) energy, and more particularly, with, among other things, EM energy from EM radiation at radio frequencies (RF) (hereinafter “RF energy”).

### BACKGROUND

Pyrolytic self-cleaning ovens are commercially available. In pyrolytic cleaning, an oven cavity, for example, is heated to a temperature of about 400° C. or more for about 90 minutes; such heating may reduce spills inside the oven to a grey ash that can be wiped away once the oven has cooled.

The walls of pyrolytic, sometimes called pyrolytic “self-cleaning,” ovens are sometimes coated with materials acting as oxidation catalysts, usually in the form of catalyst particles in a binder matrix.

EM waves have been used in various applications to supply energy to objects. In the case of radio frequency (RF) radiation for example, EM energy may be supplied using a magnetron, which is typically tuned to a single frequency for supplying EM energy only in that frequency. One example of a commonly used device for supplying EM energy is a microwave oven. Typical microwave ovens supply EM energy at or about a single frequency of 2.45 GHz.

### SUMMARY

Aspects of some embodiments of the present invention concern a pyrolytic self-cleaning oven that may heat the walls of the oven cavity more efficiently than the gas in the volume of the oven cavity. In some embodiments, the gas (e.g., air) in the volume of the oven cavity may be heated mainly by thermal contact with the heated cavity walls. Such embodiments may be more efficient in terms of energy consumption (e.g., may consume less energy) compared to existing ovens, where gas in the cavity volume is first heated, and the cavity walls heat only by thermal contact with the heated gas.

In some embodiments, a wall of the oven cavity to be cleaned may be heated by RF energy. The RF energy may be absorbed in the wall, and thus heat the wall making debris attached to the wall more easily removable. In some embodiments, the wall may be cleaned by such heating when the cavity is empty of solid material and nearly all the RF energy applied to the cavity, (e.g., 70%, 80%, 90% or more of this energy) may be utilized for heating the wall. In some embodiments, a surface of the wall may absorb the RF energy and thus may be heated, while wall portions away of the surface may be heated by convection of heat from the surface more than by interaction with the RF energy.

Aspects of some embodiments of the invention may include an apparatus including a casing having a wall and defining a cavity. The apparatus may also include a first RF feed that feeds RF energy to the cavity at a first frequency range. As used herein, “applying or feeding energy at a frequency range,” may include applying or feeding the energy at one or more frequencies within the frequency range. The apparatus may also include a controller, configured to control RF energy fed into the cavity via the first RF feed. In some embodiments, the wall may comprise a frequency selective surface (FSS) that selectively absorbs RF energy at the first frequency range. The controller may control feeding RF energy to the cavity via the first RF feed to heat at least a portion of the wall to a temperature above a specified lower temperature threshold for at least a specified period of time. The specified temperature and time may be sufficient to pyrolytically clean the wall.

Aspects of some embodiments of the invention may include an apparatus that includes a casing having a wall and defining a cavity and a first RF feed that feeds RF energy to the cavity at a first frequency range. The apparatus may also include a controller, for example, configured to control RF energy fed into the cavity via the first RF feed. In some embodiments, the wall may comprise a frequency selective surface (FSS) that selectively absorbs RF energy at the first frequency range. The controller may be configured to control feeding RF energy to the cavity via the first RF feed to heat the wall such that dirt or contaminants, grime in the apparatus can be removed by wiping more easily than before heating.

Aspects of some embodiments of the invention may include an apparatus that includes a casing having a wall and defining a cavity. The apparatus may also include a first heating unit for heating at least a portion of the wall and a second heating unit for heating an object placed in the cavity. In some embodiments, operating the first unit alone heats the wall (or a portion thereof) without significantly heating the air in the cavity.

Aspects of some embodiments of the invention may include an apparatus comprising a casing having a wall and defining a cavity. The apparatus may also include an RF feeding system configured to feed RF energy to the cavity at two different frequencies or more. The apparatus may also include a frequency selective surface (FSS) that is resonant at one of said two different frequencies and is not resonant at the second one of the two different frequencies. In some embodiments, the RF feeding system may be configured to feed RF energy to the cavity at two different frequency ranges or more. The apparatus may also include a frequency selective surface (FSS) that is resonant at one or more frequencies of one of the two different frequency ranges and is not resonant at frequencies of the second one.

Aspects of some embodiments of the invention may include a method of operating a self-cleaning oven having a cavity. The method may include receiving indication that self-cleaning is to be carried out, and, in response to receiving the indication, feeding RF energy into the cavity at a frequency absorbed by a wall of the cavity or a portion of the wall. The method may also include stopping RF energy feeding when or after the wall is at temperatures between 400° C. and 550° C. for a specified period of time. In some embodiments, the specified period of time is longer than 60 minutes.

Aspects of some embodiments of the invention may include an apparatus comprising a casing having a wall and defining a cavity, and a first RF feed that feeds RF energy to the cavity at a first frequency range. The wall may include RF absorbing particles that absorb RF energy in the first frequency range. The first RF feed may be configured to supply RF energy to the cavity, such that the RF absorbing particles heat the wall to temperatures between 400° C. and 550° C.

Aspects of some embodiments of the invention may include a kit that includes a sheet having a frequency selective surface that absorbs energy selectively at a specified radio frequency range. The sheet may be configured to be attached to a wall of a cooking oven (e.g., a domestic cooking oven). The kit may further include instructions to attach the FSS to a wall of a cavity of a cooking oven and to operate the oven to supply to the cavity RF energy at a radio frequency range absorbed by the FSS. The frequency range may be specified, for example, by specifying an operation mode to be selected by the user. For example, the oven may include a knob that may point to a symbol, and the instructions may direct a user to switch the knob to point to the symbol. Pointing the knob to the symbol may control energy application to occur at the frequency range absorbed by the FSS. In some embodiments, the instructions may be carried on a machine readable element, and the oven may include or be in communication with a reader configured to read the machine readable element. For example, the FSS may carry a barcode. A controller in the oven may be configured to receive a code from a barcode reader, and once the code on the FSS is read by the reader, the controller set the oven to the pyrolytic cleaning mode, e.g., by switching the RF feeding system to feed energy in the frequency range absorbed by the FSS.

Aspects of some embodiments of the invention may include a method of operating an oven that includes a cavity. The method may include attaching to a wall, such as an inner wall of the cavity, a sheet having a frequency selective surface that absorbs energy selectively at a specified radio frequency range. The method may also include operating the oven to supply energy to the cavity at the specified energy range, or other energy range.

Aspects of some embodiments of the invention may include a method of cleaning a wall, such as an inner wall, an inner wall of an oven. The method may include supplying RF energy to a cavity of the oven at a first frequency range, such that an inner wall of the cavity heats the without significantly heating air in the cavity. The method may also include wiping the wall. Aspects of some embodiments of the invention may include a casing having one or more walls and defining a cavity, wherein one of the one or more walls comprises a frequency selective surface (FSS) that selectively absorbs RF energy within a first frequency range, a first RF feed configured to RF energy to the cavity within the first frequency range, and a controller configured to control RF energy fed into the cavity via the first RF feed to heat at least a portion of one of the one or more walls to a temperature above a specified lower temperature threshold for at least a specified period of time.

Aspects of some embodiments of the invention may include a casing having at least one wall and defining a cavity, and a first RF feed that feeds RF energy to the cavity within a first frequency range, and a controller, configured to control RF energy fed into the cavity via the first RF feed, wherein the wall comprises a frequency selective surface (FSS) that selectively absorbs RF energy at the first frequency range, and the controller controls feeding RF energy to the cavity via the first RF feed such that grime in the apparatus can be removed by wiping more easily than before heating. In some embodiments, the specified period of time is at least 60 minutes. In some embodiments, the specified period of time is at least 90 minutes. In some embodiments, the specified lower temperature threshold is 400° C. or greater. In some embodiments, the FSS is located in the vicinity of the one or more walls. In some embodiments, the FSS is integral with the one or more walls. In some embodiments, the apparatus may further comprise a heating unit configured to heat an object placed in the cavity. In some embodiments, the apparatus may comprise an RF feed that supplies RF energy within a second frequency range, the second frequency range different from the first frequency range. This may be the first RF feed or a second RF feed. In some embodiments, the second RF feed is configured to heat an object placed in the cavity. In some embodiments, the FSS is resonant at one or more frequencies within the first frequency range. In some embodiments, the FSS is not resonant with any of the frequencies within the second frequency range. In some embodiments, the first and second frequency ranges do not overlap. In some embodiments, the second RF feed is configured to heat an object placed in the cavity. In some embodiments, the first frequency range is between 2400 and 2500 MHz, and the second frequency range is between 800 and 1000 MHz.

Aspects of some embodiments of the invention may include a casing having one or more walls and defining a cavity, a first heating unit configured to heat at least a portion of the one or more walls, and a second heating unit for heating an object placed in the cavity, wherein the first heating unit is further configured to heat the at least one wall without significantly heating air in the cavity. In some embodiments, the first heating unit comprises a first RF feed, configured to feed the cavity with RF energy within a first frequency range, and a frequency selective surface (FSS) resonant with one or more frequencies within the first frequency range.

In some embodiments, the first heating unit comprises, a nozzle configured to spray an RF absorbing material on the one or more walls, and an RF feed configured to feed RF energy to the cavity to heat the RF absorbing material on the one or more walls. In some embodiments, the FSS is located in the vicinity of the one or more walls. Additionally, or alternatively, the FSS may be integral with the one or more walls. In some embodiments, the first heating unit comprises a first RF feed that feeds the cavity with RF energy within a first frequency range and wherein the second heating unit comprises a second RF feed that feeds RF energy within a second frequency range, the second frequency range being different from the first frequency range. In some embodiments, the apparatus may includes a frequency selective surface (FSS) that is resonant with one or more frequencies within the first frequency range. In some embodiments, comprising a frequency selective surface (FSS) that is not resonant at any of the frequencies included in the second frequency range.

Aspects of some embodiments of the invention may include a casing having at least one wall and defining a cavity, an RF feeding system configured to feed RF energy to the cavity at two or more frequencies, and a frequency selective surface (FSS) that is resonant with only one of said two frequencies or more. In some embodiments, the wall may comprise an enamel layer between the FSS and the cavity. In some embodiments, the cavity has dimensions that support at least one standing wave having a frequency in the first frequency range and an energy distribution with a maximum near the at least one wall. In some embodiments, the apparatus may include a mode stirrer configured to stir EM modes excited in the cavity to increase an amount of energy at the at least one wall. In some embodiments, the apparatus may include a field rotating element configured to rotate an electric field pattern excited in the cavity by the first RF feed. For example, the field rotating element may include a ferrite element. In some embodiments, the apparatus further includes a controller configured to control RF energy supplied to the cavity based on information indicative of an amount of EM energy received from the cavity.

Aspects of some embodiments of the invention may include a method comprising receiving indication that self-cleaning is to be carried out, and in response to the indication that self-cleaning is to be carried out, feeding RF energy to the cavity at a frequency absorbed by a portion of a wall of the cavity, and stopping RF energy feeding when or after the wall has been maintained between 400° C. and 550° C. for 60 minutes or more. In some embodiments, the wall includes a frequency selective surface (FSS), and feeding RF energy comprises feeding energy at a resonance frequency of the FSS. In some embodiments, the method may include receiving an indication of an amount of EM energy received from the cavity, and wherein the feeding RF energy to the cavity is performed in accordance with the indication of the amount of EM energy received from the cavity. In some embodiments, the method may include stirring EM modes in order to increase the amount of energy absorbed in the wall, and/or rotating an EM field pattern excited in the cavity. In some embodiments, rotating the EM field pattern comprises using a field rotating element having at least one of magnetic anisotropy and electric anisotropy.

Aspects of some embodiments of the invention may include a casing having one or more walls and defining a cavity, and a first RF feed that feeds RF energy to the cavity at a first frequency range, wherein at least one wall of the one or more walls comprises RF absorbing particles that absorb RF energy in the first frequency range, and the first RF feed is configured to supply RF energy to the cavity, such that the RF absorbing particles absorb at least a portion of the RF energy and heat the at least one wall to between 400° C. and 550° C. In some embodiments, the particles include one or more oxidation catalysts, for example, Cerium(IV) oxide.

Aspects of some embodiments of the invention may include a sheet having a frequency selective surface that absorbs energy selectively within a specified radio frequency range, the sheet being configured to attach to a wall of an oven, and instructions for attaching the FSS to the wall of the oven and for operating the oven to supply RF energy to a cavity of the oven within the specified radio frequency range. In some embodiments, the instructions comprise instructions for detaching the sheet from the wall and for wiping the wall to clean it. In accordance with some exemplary embodiments of the invention there is provided a method of operating an oven comprising a cavity, the method comprising attaching to a wall of the cavity a sheet having a frequency selective surface that absorbs energy selectively within a specified radio frequency range, and operating the oven to supply energy to the cavity within the specified energy range. In some embodiments, operating the oven is carried out when the oven is empty. A method according to some embodiments may further include detaching the sheet from the wall after operating the oven; and wiping the wall to clean it. In some embodiments, operating the oven comprises operating to heat the wall to between 400° C. and 550° C. for period of 90 minutes or longer. In accordance with some exemplary embodiments, there is provided a kit comprising an oven (e.g., a domestic oven) and instructions to operate the oven in accordance with a method described herein.

Aspects of some embodiments of the invention may include a method of cleaning a wall of an oven having a cavity, the method comprising supplying RF energy to the cavity at a first frequency range that heats a cavity wall without significantly heating air in the cavity; and wiping the wall. The preceding summary is merely intended to provide the reader with an overview of certain aspects of disclosed embodiments and is not intended to restrict in any way the scope of the claims. In addition, it is to be understood that both the foregoing general description and the following detailed description are exemplary and explanatory only and are not restrictive of disclosed principles.

### BRIEF DESCRIPTION OF THE DRAWINGS

The accompanying drawings, which are incorporated in and constitute a part of this specification, illustrate various embodiments and exemplary aspects of disclosed embodiments and, together with the description, explain disclosed principles. In the drawings:

FIG. 1 is a diagrammatic illustration of an apparatus according to some embodiments of the invention;

FIG. 2 is a diagrammatic illustration of a cross section of a wall of an apparatus according to some embodiments of the invention;

FIG. 3 is a diagrammatic illustration of an apparatus according to some embodiments of the invention;

FIG. 4 is a block diagram of apparatus according to some embodiments of the invention;

FIG. 5 is a diagrammatic representation of an exemplary RF-based heating unit that may be used according to some embodiments of the invention;

FIG. 6 illustrates several examples of shapes of FSS that may be used in some embodiments of the invention;

FIG. 7A is a flowchart illustrating a method of operating a self-cleaning oven according to some embodiments of the invention;

FIG. 7B is a flow chart of a method for applying EM energy to an energy application zone, in accordance with some embodiments of the present invention;

FIG. 8 is a diagrammatic illustration of an oven according to some embodiments of the invention;

FIG. 9 is a diagrammatic illustration of an oven according to some embodiments of the invention;

FIG. 10 is a flowchart of actions that may be taken in cleaning an oven in a method according to some embodiments of the invention; and

FIG. 11 diagrammatically illustrates an oven, sheet, and instructions that may form kits according to some embodiments of the invention.

### DETAILED DESCRIPTION OF EMBODIMENTS

Reference will now be made in detail to embodiments, examples of which are illustrated in the accompanying drawings. When convenient, the same reference numbers are used throughout the drawings to refer to the same or like parts.

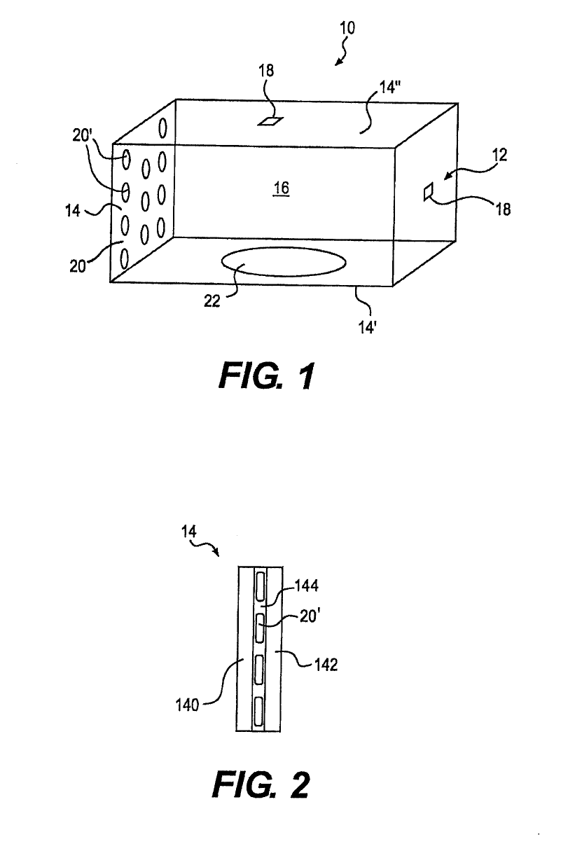

FIG. 1 is a diagrammatic illustration of an apparatus 10 according to some embodiments of the invention. Apparatus 10 is shown to include an enclosure, e.g., casing (12). The enclosure may include walls, for example, wall 14. Casing 12 may define an energy application zone (e.g., cavity 16). Apparatus 10 may also include one or more radiating elements (e.g., RF feeds such as the two shown in FIG. 1, marked collectively as 18). In operation, the RF feed(s) may feed cavity 16 with RF energy.

As shown in the FIG. 1, apparatus 10 may include a frequency selective surface (FSS) 20, which may include a surface that absorbs, reflects or transmits radiation in a selected frequency range. For example, an FSS 20 may be chosen to absorb RF energy in a selected frequency range. FSS 20 may be in the vicinity of wall 14, and may overlay wall 14 wholly or partially. FSS 20 may be covered with other layers, as shown, for example, in FIG. 2, and is not necessarily an outer or inner surface of any part of apparatus 10. Optionally, FSS 20 may form part of wall 14 or may be embedded in wall 14. In some embodiments, one or more of RF feed(s) 18 may be configured to supply RF energy to cavity 16, such that an inner surface of wall 14 (e.g., a surface that faces cavity 16) heats to clean the wall by pyrolysis, a process referred to as pyrolytic cleaning. In pyrolytic cleaning, contaminants, dirt and/or grime change properties such that they assume a removable form due to the exposure to heat. For example, wiping the dirt after pyrolysis may be more easy than before the heating. In some embodiments, the wall may include oxidation catalysts that may allow pyrolytic cleaning at lower temperatures than would be required without the catalysts. In some embodiments, pyrolytic cleaning may occur at temperatures of about 430° C. or more (e.g. between about 400° C. and about 550° C.) for times such as about 90 minutes.

Frequency selective surface 20 may be fabricated as an array of electrically conducting elements 20′ or as an array of apertures 20′ in an electrically conducting sheet, referred herein as a perforated sheet. In some embodiments, the array may be periodic or quasi-periodic. In some embodiments, the array is non-periodic.

The electrically conductive elements or sheet may be fabricated from metals or any other electrically conductive materials. In some embodiments, the electrical conductivity of the conducting elements or sheet may be of the same order of magnitude as that of bulk copper.

In some embodiments, a perforated sheet may be provided separate from the oven (e.g., as a stand-alone item), and may be attached (e.g., by an oven user) to the oven's wall(s) before cleaning. In some embodiments, perforated sheets may include magnets, glue, or any other means that may facilitate attaching the sheets to the oven wall. The sheets may be provided in size and shape tailored to fit wall(s) of cavity 16.

The transmission, reflection, and absorption of FSS 20 may be dependent on the frequency of operation (e.g., the frequency at which RF energy is provided to cavity 16), such that RF energy of a first frequency range may be absorbed to heat surface 20, while RF energy of a second frequency range may be absorbed by surface 20 less efficiently, or not at all. Frequencies of the second frequency range may be used, for example, for processing (e.g., heating, thawing etc.) objects in the cavity without heating the cavity walls to the high temperature they heat during pyrolytic cleaning, or even, in some embodiments, without heating the cavity walls at all. In some embodiments, the FSS is not resonant at any of the frequencies of the second frequency range. Accordingly, in some embodiments, supplying a certain amount of RF energy to the cavity at the first frequency range may heat surface 20 and/or wall 14 to temperatures between 400° C. and 550° C. while supplying the same amount of energy to the cavity at the second frequency range may heat surface 20 and/or wall 14 less (for example, up to 100-150° C.). In other embodiments, the same applied energy may not heat surface 20.

In some embodiments, an absorption coefficient of FSS 20 may depend on the polarization and/or angle of incidence of an EM wave supplied, such that even at the same frequency, EM waves of a certain polarization may be absorbed efficiently by FSS 20, while EM waves having other polarization values may be absorbed less efficiently or not at all. Similarly, EM waves supplied at one incidence angle may be absorbed more efficiently than waves supplied at other incidence angles. Such selective absorbance may be utilized in apparatuses or methods where cooking and pyrolytic cleaning occur within the same frequency range, but may be applied at mutually different polarizations, incidence angles, or the like. This may allow cooking without overheating of the walls and pyrolytic cleaning at the same frequency range, and, in some embodiments, also by the same RF energy source, although the antennas may differ, e.g., in polarization and/or orientation.

The absorption coefficient of FSS 20 may be determined by the size, shape, and/or spatial arrangement of metallic elements or apertures 20′.

In some embodiments, a metallic sheet of FSS 20 may be configured with apertures sized, shaped, and/or spatially arranged such that the metallic sheet may absorb energy within a frequency range used by the oven to cook, heat or otherwise process an object placed in the cavity. In such embodiments, cooking or other processing may be performed with the FSS removed from the cavity, and pyrolytic cleaning may be performed by attaching an FSS to the oven and supplying energy to the FSS at the normal operating frequency range of the oven. During pyrolytic cleaning, for example, the oven may or may not include an object to be processed.

An object to be processed in an oven consistent with embodiments of the present invention may include a liquid, semi-liquid, solid, semi-solid, or gas, depending upon the particular process with which the invention is utilized. The object may also include composites or mixtures of matter in differing phases. Thus, by way of non-limiting example, the term “object” encompasses such matter as food to be defrosted or cooked; clothes or other wet material to be dried; frozen organs to be thawed; chemicals to be reacted; hydrated material to be dehydrated; liquids to be heated, boiled or vaporized, or any other material for which there is a desire to process by heating and/or to apply EM energy.

The term EM energy, as used herein, includes energy deliverable by EM radiation in all or portions of the EM spectrum, including but not limited to, radio frequency (RF), infrared (IR), near infrared, visible light, ultraviolet, etc. The term RF energy, as used herein, includes energy deliverable by EM radiation in the RF portion of the EM spectrum. In one particular example, applied EM energy may include RF energy with a wavelength in free space of 100 km to 1 mm, which corresponds to a frequency of 3 KHz to 300 GHz, respectively. In some other examples, the applied EM energy may fall within frequency bands between 500 MHz to 1500 MHz or between 700 MHz to 1200 MHz or between 800 MHz-1 GHz. Applying energy in the RF portion of the EM spectrum is referred herein as applying RF energy, and heating by applying RF energy may be referred to as RF heating. Microwave and ultra high frequency (UHF) energy, for example, are both within the RF range. In some other examples, the applied EM energy may fall only within one or more ISM frequency bands, for example, between 433.05 and 434.79 MHz, between 902 and 928 MHz, between 2400 and 2500 MHz, and/or between 5725 and 5875 MHz.

Apparatus 10 may include any apparatus that may benefit from selective heating of its walls, including, for example, a self-cleaning oven. The apparatus may include a domestic oven, industrial oven or another kind of apparatus. A self-cleaning oven may include any oven which uses high temperature to burn off leftovers from baking.

Cavity 16 is shown in FIG. 1 to have an exemplary shape of a rectangular box. In other embodiments, cavity 16 may have other shapes, for example, a cylinder, a hemisphere, a sphere, a cube, any combination of such shapes, or any other suitable shapes.

Casing 12 may have at least one wall 14 enclosing cavity 16. In some embodiments, wall 14 may be flat as shown; in other embodiments wall 14 may be curved, for example, when casing 12 encloses a cylindrical cavity.

In the following, embodiments are described where wall 14 or a part thereof is shown to be heated. Other walls, to the extent other walls are provided, may or may not be similarly heated. For example, in the depicted embodiment in FIG. 1, a lower wall 14′, also referred to as floor 14′, may support a tray 22 that may be removable and may be cleaned separately from the walls of the casing. Such tray may protect the floor from spilling, and therefore, in some embodiments, floor 14′ may not have FSS in its vicinity. Similarly, a door (not shown), a ceiling (14″) or any other of the casing walls may or may not have FSS in its vicinity. In some embodiments, differing walls may have differing FSS's, such that each wall may be pyrolytically cleaned at a different frequency. The walls may be cleaned one at a time, and the user may provide instructions as to a sequence in which they are cleaned.

RF feed 18 may include a radiating element, for example, an RF antenna, and/or an aperture in a waveguide. Feed 18 may be connected to an RF source via a waveguide, a coaxial cable, or any transmission line known in the art. The RF source, feed, and transmission line between them may form together an RF feeding system. An RF feeding system may also include a controller, which may control the frequency, power, time duration, and/or other characteristics of the RF energy fed by the system. The RF source may or may not make part of apparatus 10. The RF source may be connected to feed 18. In some embodiments, the RF source may be separated from apparatus 10, and may be used for feeding more than one apparatus with EM energy. Suitable arrangements are shown, for example, in WO2009/104191.

In some embodiments, FSS 20 may be made of Nichrome™, graphite, or other materials having a suitable electrical conductivity. For example, the perforated sheet or the conductive elements 20′ of FSS 20 may be made of Nichrome™ having a thickness of about 5 to 50 microns. In some other examples, the perforated sheet or the conductive elements 20′ of FSS 20 may be made of graphite, thicker than 50 microns. More generally, FSS 20 may be made of materials that, given the geometry of the FSS, may heat when supplied with RF energy at the first frequency range, and may heat less or not at all when supplied with RF energy at the second frequency range. In some embodiments, thicker elements (or sheets) and/or higher RF power may be used with conductors having higher electrical conductivity, while elements of smaller dimensions and/or application of RF energy at lower power may be used with conductors having less electrical conductivity.

In some embodiments, the geometry of FSS 20 may be defined by the size, shape, and spatial arrangement of elements or apertures 20′.

FSS 20 may be heat resistant or heat proof, at least at the temperature range used for pyrolytic cleaning (e.g., up to about 550° C.). Being heat resistant or heat proof may include retaining function for a specified service life. For example, in some embodiments, a heat resistant or heat proof FSS retains functionality for 10 years at monthly use. A heat-proof stand-alone FSS may retain functionality for a single use or a small number of uses. A stand-alone FSS may be an FSS made to be attached to the oven by the end-user, like, for example, an FSS that is part of a kit discussed below.

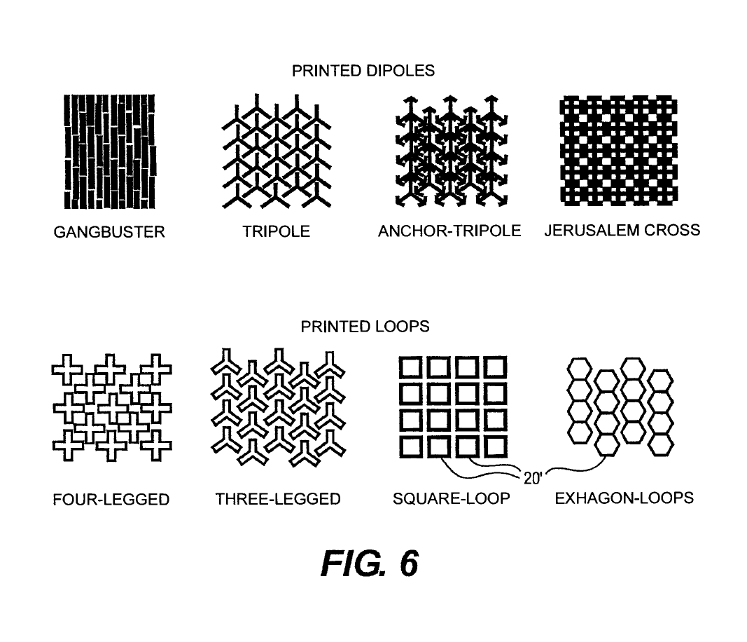

FSS elements 20′ may all be of the same shape or may include elements or apertures of various shapes. Some exemplary possible shapes include circles, triangles, rectangles, squares, hexagons, and other simple geometric shapes. In some embodiments, FSS elements 20′ may have any one or more of the shapes depicted in FIG. 6. Shape, size, and spatial arrangement of elements or apertures 20′ may be determined by simulation, which may take into account the structure of cavity 16, the position of feeds 18, and other variables that might affect the field developed in the cavity in the presence of FSS 20. In some embodiments, FSS 20 may be resonant with at least one frequency of the first frequency range. This may be accomplished, for example, when elements or apertures 20′ are sized, shaped, spatially arranged, and/or distanced from each other to be in resonance with one or more of the frequencies at which energy is supplied to cavity 16 by feed 18.

FSS 20 may be in the vicinity of wall 14, such that heat generated by FSS 20 may efficiently heat wall 14. In some embodiments, 80%, 85%, 90% or more, for example, 99% of the heat generated by FSS 20 may contribute to elevation of a temperature of wall 14, a surface thereof or other portions thereof. In some embodiments, FSS 20 is integral with wall 14 (e.g., embedded therein), for example, as illustrated in FIG. 2, which diagrammatically shows a cross section of wall 14. As shown, wall 14 may include a base 140, a coating 142, and FSS 20 located between base 140 and coating 142. The coating may face cavity 16. In some embodiments, FSS 20 may be embedded in coating 142. Base 140 may be made, for example, of stainless steel, tin, or any other material used in the field of constructing ovens. Coating 142 may include, for example, enamel (e.g., vitreous enamel, or other material used for coating oven wall surfaces facing the oven cavity). Coating 142 may be made of an RF transparent material, for example, in the first frequency range. Metallic elements 20′ may be isolated from each other with an electrically insulating material 144 which may be the same as the base material, the same as the coating material, or may be made of another material, for instance, quartz, glass, or other ceramic material, in which metallic elements 20′ may be embedded. In some embodiments, the oven may include FSS's for heating more than one wall. It is noted that wall 14 is meant to be exemplary. Any of the embodiments, principles, configurations, methods and concepts may be applied to any wall in embodiments of the present invention.

Wall 14, or at least its cavity facing surface, may be heated to temperatures of between about 400° C. and 550° C. In some embodiments, different portions of the wall are heated to different temperatures. For example, wall portions that are closer to metallic elements 20′ may be heated to a higher temperature than wall portions that are more distant from metallic elements 20′.

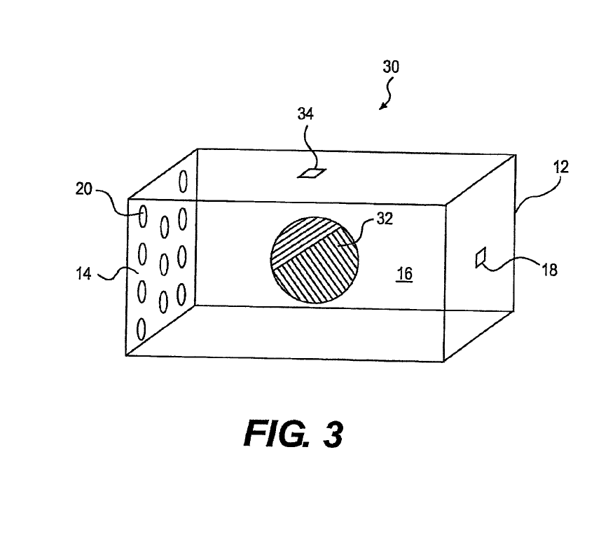

FIG. 3 is a diagrammatic illustration of an apparatus 30 in accordance with some embodiments of the invention. Similarly to apparatus 10, apparatus 30 may include casing 12 having wall 14 and defining cavity 16. Apparatus 30 may include a frequency selective surface (FSS) 20, which may selectively absorb RF energy of a given frequency range. Apparatus 30 may also include two heating units: a first heating unit 32, for heating an object in the cavity; and a second heating unit (34) for heating at least one wall or part of a wall defining the cavity (e.g., by heating FSS 20). Heating the wall(s) or part thereof (e.g., by heating unit 34) may be carried out in a similar manner to what is described in reference to FIG. 1 or FIG. 2. Heating the object may be carried out (e.g., by heating unit 32), for example, by heating air in the cavity, supplying the cavity with hot air, hot air impingement, and/or by directly heating the object (e.g., with RF energy that may be absorbed in the object). In some embodiments, the object may be heated by RF energy that is absorbed selectively in the object, and less efficiently in the walls or other portions surrounding the object in cavity 16. In some embodiments, the first heating unit (e.g., the heating unit configured to heat the wall), does not heat significantly air in the cavity. The first heating unit may be considered to heat the wall without significantly heating the air in the cavity if, when only the first heating unit is active, most of the temperature rise of the air is due to thermal contact with the wall.

Heating unit 32 may include a hot air blower embedded in one or more of the walls of the oven cavity. Additionally or alternatively, heating unit(s) included in an apparatus according to some embodiments of the invention to process (e.g., heat) objects placed in the cavity may include radiators, IR heaters, resistor-based heaters, RF feeds, or any other unit that may be used to heat objects.

In some embodiments, a single heating unit may be used both for heating an object (e.g., for cooking, and for heating a wall, e.g., for pyrolytic cleaning). In some embodiments, the wall and the object may be heated by RF energy, but at different frequencies. The different frequencies may be of different frequency ranges. A single heating unit may apply energy in both frequency ranges and a controller may control at which frequency or frequency range to operate the oven at a given time. In some embodiments, both heating an object placed in the cavity and heating a wall of the cavity may comprise supplying to the cavity RF energy of the same frequency range.

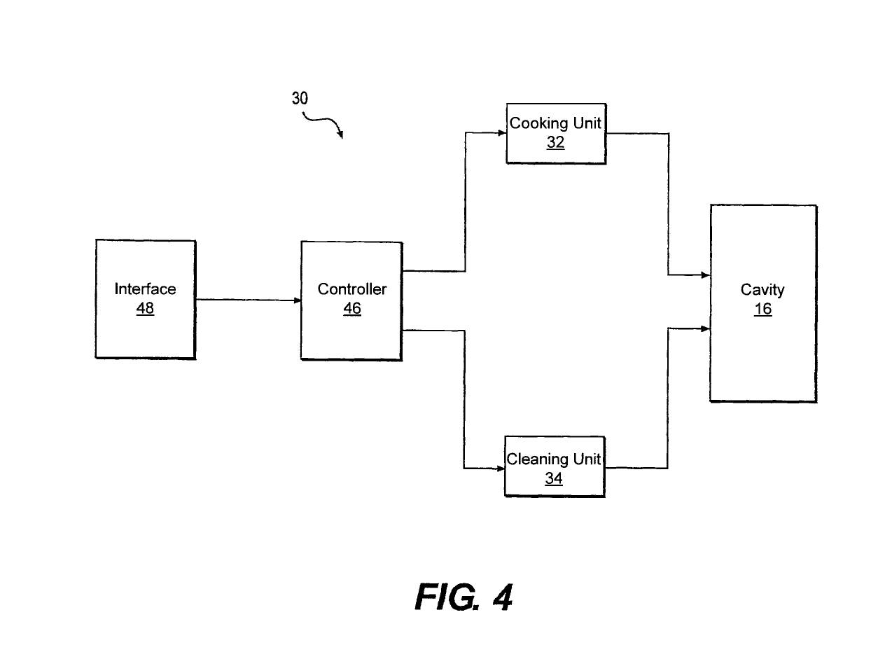

FIG. 4 is a block diagram of apparatus 30 according to some embodiments of the present invention. As shown in FIG. 4, apparatus 30 may include two heating units, 32 and 34. Heating unit 32 may be configured to heat an object placed in cavity 16 (e.g., for cooking, sintering, polymer curing, or any other processing that may require heating). Heating unit 34 may be configured to heat at least a portion of wall 14 of casing 12 defining cavity 16 (e.g., for cleaning the wall, for controlling a temperature gradient inside the cavity, or for any other cause that may benefit from selective heating of the wall).

Apparatus 30 may have two or more operation modes, including, for instance, a first mode in which heating unit 32 is active and heating unit 34 is not, and a second mode, in which heating unit 34 is active, and heating unit 32 is not. In the following, these modes will be referred to as cooking mode and cleaning mode, for convenience. Similarly, a heating unit configured to heat an object placed in the cavity 16 may be referred to as a cooking unit and a heating unit configured to heat a wall may be referred to as a cleaning unit. The invention, however, encompasses embodiments where cooking modes and/or cooking units heat for purposes other than cooking and/or embodiments where cleaning modes and/or cleaning units heat for purposes other than cleaning. Apparatus 30 may have other modes. For example, apparatus 30 may have a combined mode, in which an object is heated with heating unit 32 while a wall is heated with heating unit 34.

Heating units 32 and 34 may be controlled by a controller 46. Controller 46 may be configured to operate apparatus 30 in one or more of the above modes, for example, to activate heating unit 34 and at the same time deactivate heating unit 32. Controller 46 may also be configured to operate the heating units in accordance with different heating plans. For example, a cooking unit (e.g., heating unit 32) may have a first cooking plan for preparing a steak, a second cooking plan for baking bread, and a third cooking plan for steaming vegetables. Similarly, the cleaning cooking unit(s) may have different cleaning plans, for example, one plan for cleaning regular dirt, and another plan for cleaning heavier dirt. In some embodiments, cleaning heavier dirt may benefit from longer heating times and/or higher temperatures.

In some embodiments, one or both of heating units 32 and 34 may include a controller (not shown) that controls the operation of the unit. In some such embodiments, controller 46 may control which heating unit is active at a given time.

Apparatus 30 may also have an interface 48, that may allow controller 46 to receive commands or instructions from an external source (e.g., from a user). Interface 48 may comprise a keypad, a touch screen, a barcode reader, an RFID reader, an Internet connection, or any other kind of a data entry mechanism. For example, controller 46 may receive from interface 48 a command to operate in a specific one of the operation modes and/or plans, as discussed herein.

In some embodiments, heating units 32 and 34 are separate units. In some embodiments, heating units 32 and 34 are combined. For example, both units may operate by supplying RF energy to cavity 16, possibly from a single RF energy source, but in different energy supply parameters, for example, at different frequency ranges, different EM modes, different intensities, and/or any other parameter that may be controlled and that may affect the EM field pattern excited in the cavity upon EM energy application.

In the embodiment shown in FIG. 3, RF feed 18 and heating unit 34 (which may itself include an RF feed similar to RF feed 18) may together operate as part of heating unit 34 for heating wall 14. Similarly, one or both of the RF feeds may form a part of heating unit 32 for heating or processing an object with RF energy. A feed configured to heat a wall may be placed at the wall to be heated, at an opposite wall, or anywhere else in the cavity, optionally at one or more of the walls. Similarly, an RF feed configured to heat or process an object may be anywhere in the cavity, optionally at one or more of the walls (e.g., wall 14, ceiling 14″ or floor 14′). Additionally or alternatively, one or more feeds configured to heat an object in cavity 16 may be at a different location in the cavity, optionally at the walls. In some embodiments, apparatus 30 may include more than one RF feed for heating the walls, and/or more than one RF feeds for RF heating of objects placed inside the cavity.

In some embodiments, heating unit 34 (e.g., via RF feed 18), may feed cavity 16 with RF energy at a first range of frequencies that may be absorbed by FSS 20, for example between 2400 MHz and 2500 MHz. The first range of frequencies may include a single frequency or a narrow frequencies range (e.g., less than 10 MHz, 20 MHz or 50 MHz). Heating unit 32 (e.g., by RF feed 18 or a different RF feed not shown), may feed cavity 16 with RF energy at a second range of frequencies not absorbed by FSS 20 or absorbed less efficiently thereby, for example, between 800 MHz and 1000 MHz or between 400 MHz and 1000 MHz or between 600 MHz and 800 MHz. The second range of frequencies may include a single frequency or a narrow frequencies range, e.g., less than 10 MHz, 20 MHz or 50 MHz. Thus, RF heating of an object placed in cavity 16 may be accomplished using heating unit 32, without significantly heating wall 14 via FSS 20. In some embodiments, the two frequency ranges do not overlap. In some embodiments, the two frequency ranges may overlap to some extent. For example, in some embodiments, such overlap may be used for heating the air in cavity 16 (in addition to or instead of by heating unit 32).

In some embodiments, wall 14 may be heated by FSS 20 by energy fed by the cooking unit. Optionally, such heating may be to a lower temperature than that obtained with the cleaning unit, for example, up to 150° C. or 200° C. Such heating may be used, for example, to heat air in the vicinity of the object to be heated.

In some embodiments, an RF source used for cleaning unit (e.g., for pyrolytic cleaning) may be different and/or separated from an RF source used for heating unit 32 (e.g., for cooking an object). In some embodiments, the feeds may be different, but may receive RF energy from the same RF source, which may be a variable frequency RF source. The source may supply energy at a first frequency range when the oven is in cleaning mode and at a second frequency range when the oven is at cooking mode.

Consistent with some embodiments of the present invention, RF feed(s) 18 may excite in cavity 16 an EM field pattern, associated with an EM energy density distribution. In some embodiments, feed(s) 18 and the RF source that supplies the RF energy to the feed(s) may be configured such that FSS 20 is at a maximal or near maximal energy density distribution. In this context, being near a maximum or maximal energy density distribution may mean that the FSS is closer to a maximum than to a minimum. In some embodiments, the FSS is near or at a maximum in the energy density distribution less than half of the operation time (e.g., the time in which the EM field pattern is excited), while in other embodiments the FSS is at the maximum most of the time, at least 90% of the time, or even all the time.

In some embodiments, the field pattern and/or energy density distribution may change during heating. Thus, consistent with some embodiments, controller 46 may be configured to adjust energy application to cavity 16 to follow such changes, for example, to maintain a maximum of the energy distribution at FSS 20. For example, controller 46 may control the frequency, phase, or other dimensions of the modulation space (MS, see explanation below) at which energy is supplied to cavity 16 so as to maximize the interaction between the applied energy and FSS 20.

The term “modulation space” or “MS” may be used to collectively refer to all the parameters that may affect a field pattern in cavity 16 and all combinations thereof. In some embodiments, the “MS” may include all possible components that may be used and their potential settings (absolute and/or relative to others) and adjustable parameters associated with the components. For example, the “MS” may include a plurality of variable parameters, the number of feeds, their positioning and/or orientation (if modifiable), the useable bandwidth, a set of all useable frequencies and any combinations thereof, power settings, phases, etc.

The term “modulation space element” or “MSE,” may refer to a specific set of values of the variable parameters in a modulation space (MS). Therefore, the MS may also be considered to be a collection of all possible MSEs. For example, two MSEs may differ one from another in the relative amplitudes of the energy being supplied to a plurality of feeds. For example, an MSE may have a specific frequency F(i), a specific phase P(i), and a specific amplitude A(i) (F(i), P(i), A(i)). If even one of these MSE variables changes, then the new set defines another MSE. For example, (3 GHz, 30°, 12 V) and (3 GHz, 60°, 12 V) are two different MSEs, although only the phase component is different.

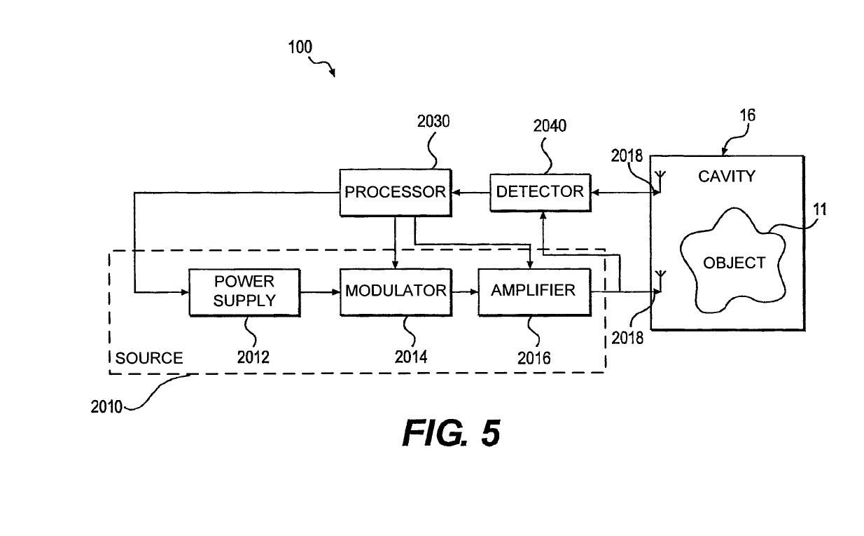

An RF-based heating unit used in some embodiments of the present invention , whether it is a cleaning unit, such as heating unit 34 or a cooking unit, such as heating unit 32, may be constructed in according with FIG. 5, which provides a diagrammatic representation of an exemplary RF-based heating unit 100. In accordance with some embodiments, heating unit 100 may include a processor 2030 which may regulate modulations performed by modulator 2014. In some embodiments, modulator 2014 may include at least one of a phase modulator, a frequency modulator, and an amplitude modulator configured to modify the phase, frequency, and amplitude, respectively, of an AC waveform supplied to cavity 16 by RF power source 2012. Processor 2030 may alternatively or additionally regulate at least one of location, orientation, and configuration of each feed 2018, for example, using an electro-mechanical device. Such an electromechanical device may include a motor or other movable structure for rotating, pivoting, shifting, sliding or otherwise changing the orientation and/or location of one or more of feeds 2018. Alternatively or additionally, processor 2030 may be configured to regulate one or more field adjusting elements located in the cavity, in order to change the field pattern in the cavity. A field adjusting element (not illustrated) may be any element adjustable to change the EM wave pattern in the cavity. In some embodiments, field adjusting elements may be used to modify the field excited in cavity 16 to be concentrated near or at object 11 to be heated, e.g., in a cooking mode, or near or at wall 14 (e.g., in a cleaning mode).

In some embodiments, heating unit 100 may involve the use of at least one source 2010 configured to deliver EM energy to cavity 16. By way of example, and as illustrated in FIG. 5, source 2010 may include one or more of an RF power supply 2012 configured to generate EM waves that carry EM energy. For example, RF power supply 2012 may be a magnetron configured to generate high power microwave waves at a predetermined wavelength or frequency. Alternatively, RF power supply 2012 may include a semiconductor oscillator, such as a voltage controlled oscillator, configured to generate AC waveforms (e.g., AC voltage or current) with a constant or varying frequency. AC waveforms may include sinusoidal waves, square waves, pulsed waves, triangular waves, or another type of waveforms with alternating polarities. Alternatively, a source of EM energy may include any other power supply, such as EM field generator, EM flux generator, or any mechanism for generating vibrating electrons.

In some embodiments, source 2010 may further include a phase modulator (e.g., as part of modulator 2014) that may be controlled to time delay an AC waveform formed by RF supply 2012, such that the phase of the AC waveform may be controlled.

In some embodiments, processor 2030 may dynamically and/or adaptively regulate modulator 2014 based on feedback (e.g., an EM feedback) from the cavity. For example, processor 2030 may be configured to receive an analog or digital feedback signal from detector 2040, indicating an amount of EM energy received from cavity 16, and processor 2030 may dynamically determine a time delay at the phase modulator for the next time period based on the received feedback signal.

In some embodiments, heating unit 100 may include a frequency modulator. The frequency modulator may be part of modulator 2014. The frequency modulator may include a semiconductor oscillator configured to generate an AC waveform oscillating at a predetermined frequency. The predetermined frequency may be in association with an input voltage, current, and/or other signal (e.g., analog or digital signals). For example, a voltage controlled oscillator may be configured to generate waveforms at frequencies proportional to the input voltage.

Processor 2030 may be configured to regulate source 2010 to sequentially supply energy to cavity 16 at various MSEs within one or more predetermined MSE groups. In some embodiments, a predetermined MSE group may include a working MSE group, and the processor may be configured to cause the supply of energy at MSEs within a sub-portion of the working MSE group. A working MSE group may be a collection of MSEs selected because, in the aggregate, they achieve a desired goal, and there is diminished need to use other frequencies in the group if that sub-portion achieves the goal. Once a working MSE group (or subset or sub-portion thereof) is identified, the processor may sequentially apply energy at each MSE in the working frequency group (or subset or sub-portion thereof). This sequential process may be referred to as “MSE sweeping.” In some embodiments, based on feedback signals provided by detector 2040, processor 2030 may be configured to select one or more MSEs from an MSE group, and regulate source 2010 to sequentially apply energy to cavity 16 at these selected MSEs.

For example, processor 2030 may be configured to regulate an oscillator (e.g., RF power source 2012) to sequentially generate AC waveforms oscillating at various frequencies within one or more predetermined frequency bands, also referred herein as frequency ranges. In some embodiments, a predetermined frequency band may include a working frequency band, and the processor may be configured to cause the supply of energy at frequencies within a sub-portion of the working frequency band. A working frequency band may be a collection of frequencies selected because, in the aggregate, they achieve a desired goal, and there is diminished need to use other frequencies in the band if that sub-portion achieves the goal. Once a working frequency band (or subset or sub-portion thereof) is identified, the processor may sequentially apply power at each frequency in the working frequency band (or subset or sub-portion thereof). This sequential process may be referred to as “frequency sweeping.” In some embodiments, based on the feedback signal provided by detector 2040, processor 2030 may be configured to select one or more frequencies from a frequency band, and regulate an oscillator to sequentially generate AC waveforms at these selected frequencies.

Alternatively, or additionally, processor 2030 may be configured to regulate amplifier 2016 to adjust amounts of energy delivered via feeds 2018, based on the feedback signal. Consistent with some embodiments, detector 2040 may detect an amount of energy reflected from the cavity and/or energy coupled from one radiating element to another at a particular frequency, and processor 2030 may be configured to cause the amount of energy supplied at that frequency to be low (e.g., lower than a first threshold) when the reflected energy and/or coupled energy is low (e.g., lower than a second threshold). The amount of energy supplied to feeds 2018 by source 2010 may be controlled by controlling power, at which energy is supplied, time, during which energy is supplied, or both power and time.

In some embodiments, the heating unit (e.g., heating unit 32) may include more than one EM energy generating component or EM source. For example, each radiating element may be fed by a different source. Accordingly, at any given time, feeds 2018 may be caused to simultaneously emit EM waves at, for example, two differing frequencies to cavity 16.

In some embodiments, processor 2030 may be configured to regulate a phase modulator in order to alter a phase difference between two EM waves emitted into the cavity. In some embodiments, the source of EM energy may be configured to supply EM energy at a plurality of phases, and the processor may be configured to cause the emission of radiation at a subset of the plurality of phases. By way of example, the phase modulator may include a phase shifter. The phase shifter may be configured to cause a time delay in the AC waveform in a controllable manner within cavity 16, delaying the phase of an AC waveform anywhere from between 0-360 degrees.

In some embodiments, a splitter (not illustrated) may be provided in heating unit 100 to split an AC signal, for example generated by an oscillator, into two AC signals (e.g., split signals). Processor 2030 may be configured to regulate the phase shifter to sequentially cause various time delays such that the phase difference between two split signals may vary over time. This sequential process may be referred to as “phase sweeping.” Similar to the frequency sweeping described above, phase sweeping may involve a subset of phases, for example, a subset selected to achieve a desired energy application goal.

The processor may be configured to regulate an amplitude modulator in order to alter an amplitude of at least one EM wave emitted into the energy application zone. In some embodiments, the source of EM energy may be configured to supply EM energy at a plurality of amplitudes, and the processor may be configured to cause the emission of radiation at a subset of the plurality of amplitudes. In some embodiments, the apparatus may be configured to supply EM energy through a plurality of feeds, and the processor may be configured, for example, to supply energy with differing amplitudes simultaneously two or more feeds.

Although FIG. 5 illustrates heating unit 100 including two feeds 2018, it should be noted that any number of feeds may be employed, and the unit may select combinations of MSEs through selective use of feeds. In some embodiments amplitude may be held constant and field changes may be caused by switching between feeds and/or subsets of feeds. Further, feeds may include a device that causes their location or orientation to change, thereby causing field pattern changes. The combinations are virtually limitless, and the invention is not limited to any particular combination, but rather reflects the notion that field patterns may be altered by altering one or more MSEs.

In some embodiments, the EM field pattern excited in the cavity may be stirred with a mode stirrer. In some embodiments, the EM field pattern may be rotated with a field rotating element, which may be, for example, a ferrite. A field rotating element may be any element that may be activated to rotate an EM field inside cavity 16 or that does so without activation. In some embodiments, a field rotating element may be activated by creating anisotropy in the field rotating element, for example, by supplying electrical current to an electromagnet that resides in the vicinity of a magnetizable material.

Consistent with embodiments of the present invention, a field rotating element may have a magnetic anisotropy, an electric anisotropy, or both magnetic and electric anisotropies. The field rotating element may be composed of or include material having magnetic anisotropy, electric anisotropy, or both magnetic and electric anisotropies. The anisotropy may be inherent in the material or imposed externally. For example, magnetic anisotropy may be created by application of an external magnetic field to a magnetizable element. In some embodiments, electric and/or magnetic anisotropy may be created in the field rotating element to cause the field created by heating unit 34 to reach wall 14 better than without rotating the field.

Additionally or alternatively to mode stirring and/or field rotating, in some embodiments of the invention, cavity 16 may be dimensioned to have a reflection minimum for at least one frequency of the first frequency range.

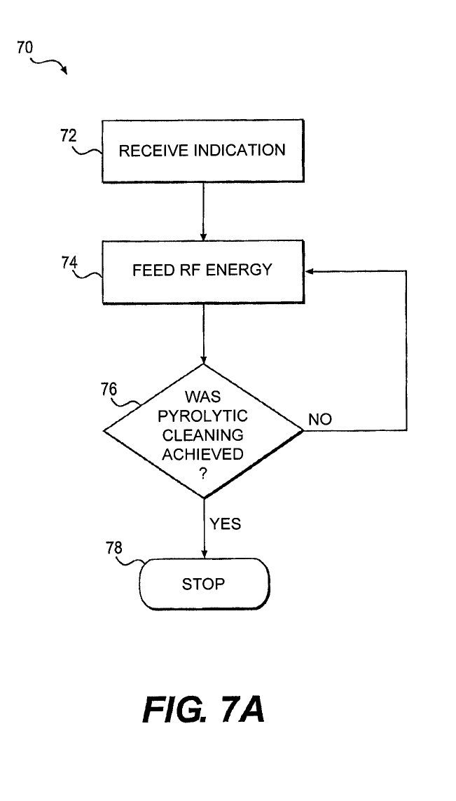

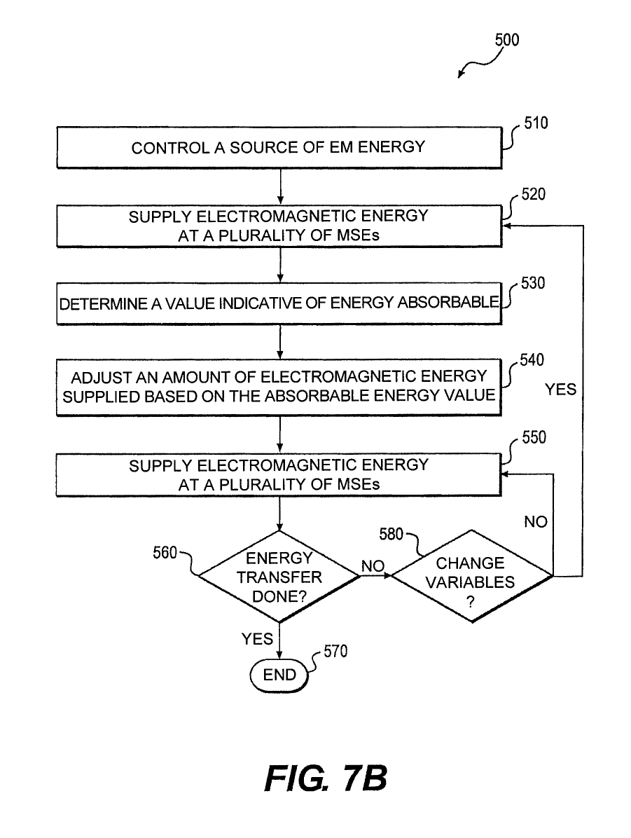

Referring now to FIGS. 7A and 7B, that present flowcharts of methods that may be used for operating apparatus 30. FIG. 7A describes an operation of an apparatus in cleaning mode according to some embodiments, for example, and FIG. 7B describes an operation of an apparatus in cooking mode according to some embodiments. The choice between the modes may be provided by a user, for instance, via interface 48.

An aspect of some embodiments of the invention may include a method 70 of operating a self-cleaning oven (e.g., oven 30). A flowchart showing actions to be taken in such a method is provided in FIG. 7 . Method 70 may include receiving indication that self-cleaning is to be carried out (step 72). In some embodiments, where different walls may be cleaned independently from each other, the indication may include the desired wall(s) to be cleaned, e.g., solely the ceiling etc. The indication may be provided by a GUI element, e.g., a keypad or a touch-screen, provided on the self cleaning oven. In some embodiments, a self-cleaning process may be carried out automatically, e.g., once a month, once a year etc. In some embodiments, the user may be requested to approve the self-cleaning process before it is carried out. In step 74, RF energy is fed into the oven cavity. Feeding RF energy may include feeding at a frequency absorbed by a wall of the cavity or a portion of this wall, e.g., by FSS 20. The method may further include checking whether pyrolytic cleaning has been achieved (step 76). If not (step 76: NO), RF energy feeding may continue. RF energy feeding 74 may be stopped (step 78) when pyrolytic cleaning is achieved (step 76: YES), for example, when the wall is at temperatures between 400° C. and 550° C. for a specified period (e.g., a period longer than 60 minutes).

Checking if pyrolytic cleaning has been accomplished may be carried out, for example, by watching the time. For example, in some embodiments, it may be known that it takes the oven to heat to pyrolytic temperature within one hour, and that this temperature should be maintained for 90 minutes. In such embodiment, the checking step may include watching if it is more than two and a half hours since RF feeding began. In some embodiments, the temperature of the wall is monitored, e.g., by temperature sensors provided on or near the wall(s), and RF energy feeding stops after the temperature is at the pyrolytic temperature for a specified time period (e.g., 90 minutes). In some embodiments, if the wall temperature rises above a certain upper threshold the RF energy feeding may stop, and will be restarted after the temperature went below a lower threshold, provided that the total amount of time spent by the wall at temperatures between the two threshold is not shorter than the specified period. Thus, RF energy feeding (step 74) may be stopped even before pyrolytic cleaning has been fully achieved, and may or may not be resumed.

In some embodiments, the method may include receiving an indication of the amount of EM energy received or absorbed by the cavity. RF energy may be fed and/or adjusted (e.g., by adjusting the frequency at which energy is emitted to the cavity) in accordance with the received indication. For example, the wall may include an FSS, and feeding RF energy may include feeding RF energy at a resonance frequency of the FSS. Feeding energy may be in the resonance frequency alone, or in a frequency range that includes the resonance frequency. In embodiments where energy is fed at a frequency range including the resonance frequency, the FSS may be resonantly excited even if the resonance shifts within this range, for example, due to temperature change. If a single frequency is fed, it may be useful to follow the resonance frequency, and adjust the frequency at which energy is fed accordingly.

Additionally, or alternatively, pyrolytic cleaning may be monitored by spectroscopy. For example, spectroscopic features detected from the cavity in the presence of dirt before and after pyrolysis may be known in advance, and the decision whether to continue feeding RF energy or not may be based on the appearance and disappearance of these features. In some embodiments, the features may include position, size, and/or width of peaks in the reflection. In some embodiments, other values or data that may be indicative of energy absorption in the wall may be followed to detect spectroscopic features. These may include, for example, the dissipation ratio, which is the ratio between the energy detected to return from the cavity, either by the feed via which it was incident (i.e., reflection) or by another feed (i.e., coupling), and the amount of supplied energy.

FIG. 7B represents a method for applying EM energy to an object placed in cavity 16 (e.g., by cooking unit 32), in accordance with some embodiments of the present invention. EM energy may be applied to an object, for example, through at least one processor implementing a series of steps of method 500 of FIG. 7B.

In certain embodiments, method 500 may involve controlling a source of EM energy (e.g., source 2010—step 510). A “source” of EM energy may include any components that are suitable for generating EM energy (e.g., RF power supply and amplifier).

The source may be controlled to supply EM energy at a plurality of MSEs (e.g., at a plurality of frequencies and/or phases and/or amplitude etc.) to at least one radiating element (e.g., feed 18 or 2018), as indicated in step 520. Various examples of MSE supply, including sweeping, may be implemented in step 520. Alternatively, or additionally, other schemes for controlling the source may be implemented so long as that scheme results in the supply of energy at a plurality of MSEs. The at least one processor may regulate heating unit 32 to supply energy at multiple MSEs to at least one emitting radiating element (e.g., feed 2018, FIG. 4). In some embodiments, processor 2030 may provide some or all of the processing instructions based on information obtained from a machine readable element (e.g., barcode or RFID tag). The machine readable element may be read by a machine reader (e.g., a barcode reader, an RFID reader) and may be provided to the processor and/or the controller by an interface (e.g., interface 48). In some embodiments, a user may provide one or more processing instructions and/or may provide other information relating to the object (e.g., an object type and/or weight) through an interface (e.g., a GUI interface, a touch screen, etc.)

In certain embodiments, method 500 may further involve determining a value indicative of energy absorbable by the object at each of the plurality of MSEs, in step 530. An absorbable energy value may include any indicator (e.g., a calculated, measured, derived, estimated or predetermined indicator) of an object's capacity to absorb energy. For example, a dissipation ratio associated with each MSE.

In certain embodiments, the method may also involve adjusting an amount of EM energy supplied at each of the plurality of MSEs based on the absorbable energy value at each MSE (step 540). For example, in step 540, at least one processor may determine an amount of energy to be supplied at each MSE, as a function of the absorbable energy value associated with that MSE.

In some embodiments, a choice may be made not to use all possible MSEs. For example, a choice may be made not to use all possible frequencies in a working band, such that the emitted frequencies are limited to a sub band of frequencies, for example, where the Q factor in that sub band is smaller or higher than a threshold. Such a sub band may be, for example 50 MHz wide 100 MHz wide, 150 MHz wide, or even 200 MHz wide or more. Such a band may be contiguous or it may include several sub-bands with un-used frequencies in between.

In some embodiments, the at least one processor may determine a weight, e.g., power level, used for supplying the determined amount of energy at each MSE, as a function of the absorbable energy value. For example, amplification ratio of amplifier 2016 may be changed inversely with the energy absorption characteristic of object 11 at each MSE. In some embodiments, when the amplification ratio is changed inversely with the energy absorption characteristic, energy may be supplied for the same amount of time at each MSE. Alternatively, or additionally, the at least one processor may determine varying durations at which the energy is supplied at each MSE. For example, the duration and power may vary from one MSE to another, such that their product inversely correlates with the absorption characteristics of the object. In some embodiments, the controller may use the maximum available power at each MSE, which may vary between MSEs. This variation may be taken into account when determining the respective durations at which the energy is supplied at maximum power at each MSE. In some embodiments, the at least one processor may determine both the power level and time duration for supplying the energy at each MSE.

In certain embodiments, method 500 may also involve supplying EM energy at a plurality of MSEs (step 550). Respective weights are optionally assigned to each of the MSEs to be supplied (step 540) for example based on the absorbable energy value (as discussed above). EM energy may be supplied to cavity 16 via radiating elements (e.g., feed 2018). In some embodiments, MSEs may be swept sequentially (e.g., across a range of cavity's resonance MSEs or, along a portion of the range).

Energy supply may be interrupted periodically (e.g., several times a second) for a short time (e.g., only a few milliseconds or tens of milliseconds). Once energy application is interrupted, in step 560, it may be determined if the energy application should be terminated. Energy application termination criteria may vary depending on application. For example, for a heating application, termination criteria may be based on time, temperature, total energy absorbed, or any other indicator that the process at issue is compete. For example, heating may be terminated when the temperature of object 11 rises to a predetermined temperature threshold. If in step 560, it is determined that energy transfer should be terminated (step 560: yes), energy transfer may end in step 570. In another example, in thawing application, a termination criterion may include an indication that the entire object is thawed.

If the criterion or criteria for termination is not met (step 560: no), it may be determined if variables should be changed and reset in step 580. The variables may include, for example, selection of MSEs, at which energy is applied and amounts of energy to be applied at each of the MSEs. If there is no need to change any variable (step 580: no), the process may return to step 550 to continue application of EM energy. Otherwise (step 580: yes), the process may return to step 520 to determine new variables. For example, after a time has lapsed, the object properties may have changed; which may or may not be related to the EM energy supply. Such changes may include temperature change, translation of the object (e.g., if placed on a moving conveyor belt or on a rotating plate), change in shape (e.g., mixing, melting or deformation for any reason) or volume change (e.g., shrinkage or puffing) or water content change (e.g., drying), change in phase of matter, chemical modification, etc. Therefore, at times, it may be desirable to change the variables of energy application. The new variables that may be determined may include: a new set of MSEs, an amount of EM energy to be supplied at each of the plurality of MSEs, power level, at which energy is supplied at each of the MSE(s) and duration at which the energy is supplied at each MSE. Consistent with some of the presently disclosed embodiments, less MSEs may be swept in step 520 performed during the energy application phase (e.g., when control returns to step 520 from step 580) than those swept in step 520 performed before the energy application phase (e.g., when control gets to step 520 from step 510), such that the energy application process is interrupted for a minimum amount of time.

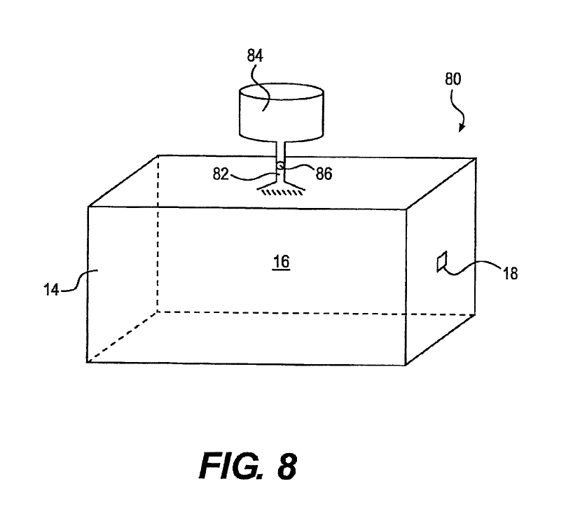

FIG. 8 diagrammatically illustrates an oven 80 consistent with some embodiments of the invention. Oven 80 may be operated in cleaning mode in accordance with method 70 described above, with some modifications discussed below. Oven 80 may include a nozzle 82 configured to spray an RF absorbing material on the cavity wall(s). Oven 80 may include more than one nozzle 82. For example, different nozzles may be positioned near different portions of the oven's walls. Nozzle 82 may be in fluid communication with a reservoir 84 of an RF absorbing material. A valve 86 may control fluid flow between reservoir 84 and nozzle 82.

In operation, for example, in response to self-cleaning request entered by a user, for example via interface 48, the nozzle may be activated to spray RF absorbing material on the wall. After at least some of the spray clings to wall 14, RF energy may be fed via feed(s) [(e.g., feed 18 or 2018 (step 74 of method 70)]. In some embodiments, the wall may be heated by RF energy absorbed by the RF absorbing material.

In some embodiments, spraying stops before RF energy feeding begins. In some embodiments, spraying continues, continuously or intermittently, after RF feeding begins, to supply fresh RF absorbing material during heating. This may be useful, for example, to replace RF absorbing material which may be deactivated during RF energy feeding (e.g., through exposure to high temperatures). Stoppage of the cleaning may be decided as described above in the context of step 76 of method 70.

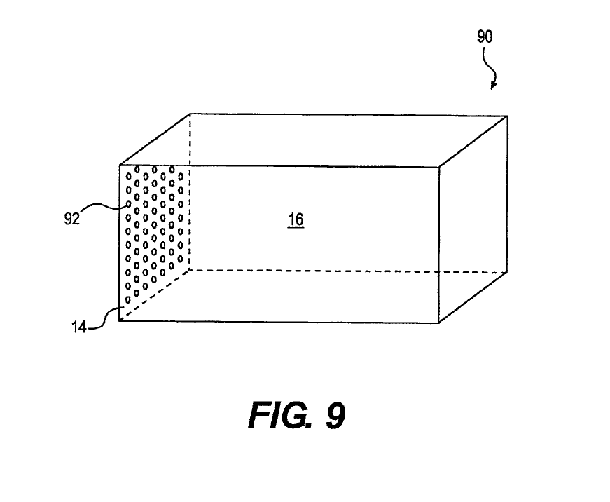

FIG. 9 diagrammatically illustrates an oven 90 according to some embodiments of the invention. Oven 90 may be operated in cleaning mode in accordance with method 70 described above. Oven 90 may include a casing, having a wall 14, and defining a cavity 16. Wall 14 may comprise RF absorbing particles 92. The size of particles 92 may be millimetric (i.e., of the size scale of a millimeter). In some embodiments, the size of the particles is sub millimetric, for example, between 100 and 900 micrometers or between 400 and 600 micrometers.

RF absorbing particles 92 may be spread in wall 14 in a single layer having a depth of, for example one quarter (25%) of the wall depth. The particles may be arranged randomly in the layer. In some embodiments the particles may be arranged in a two dimensional structure, for example, in a hexagonal, square, or rectangular array.

RF absorbing particles 92 may comprise or be composed of oxidation catalysts, for example, Cerium(IV) oxide. Other oxidation catalysts that are usually used in walls of self-cleaning ovens, for example, copper, vanadium, bismuth, molybdenum, manganese, iron, nickel, tin, niobium, chromium, tungsten, rhenium, platinum, cobalt, and their oxides, either alone or in mixtures, may also be used for particles 92, provided their RF absorbability allows wall 14 or part thereof to heat sufficiently in response to RF energy supplied to cavity 16.

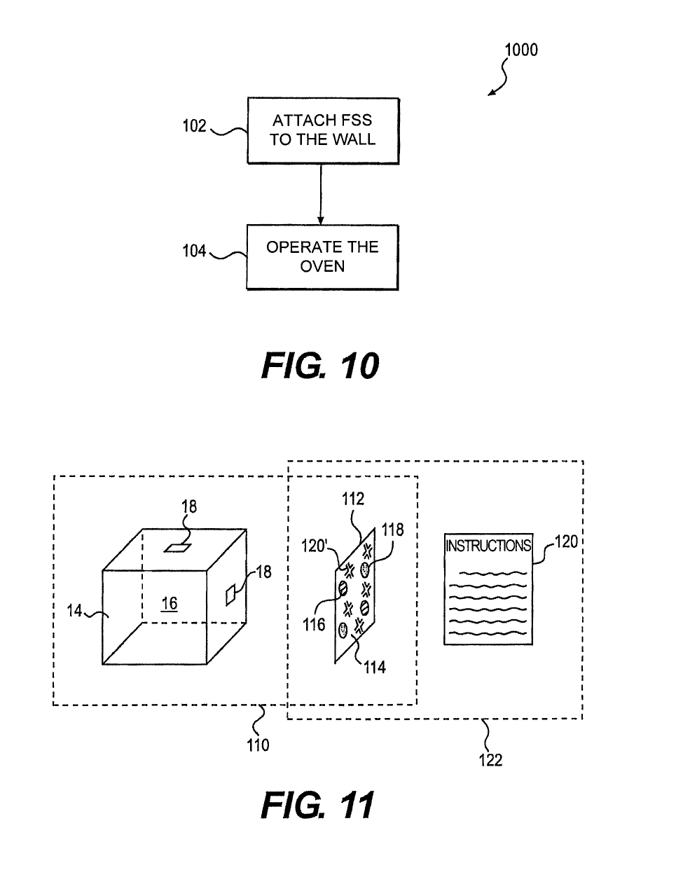

FIG. 10 is a flowchart of actions that may be taken in cleaning an oven in a method 1000 according to some embodiments of the invention. The method may include attaching (step 102) to one or more walls of the oven cavity a metallic sheet having a frequency selective surface (FSS) that may absorb energy selectively at a specified radio frequency range. The method may further include operating the oven (step 104) to supply RF energy to the cavity at the RF energy range selectively absorbed by the sheet, for example—the oven may be operated in a cleaning mode. In some embodiments, the oven may be operated to supply energy to the cavity at the RF energy range selectively absorbed by the sheet when the oven is empty from any object (e.g., food item). A food item may be any edible object or article. Foodstuff or other materials attached to the wall are not considered food items in this context. In some embodiments, operating the oven may continue until dirt in the oven (e.g., dirt on the oven walls), substantially or completely converts to a removable form, which may be removed by wiping more easily than before heating. In some embodiments, this may occur after the wall has been maintained at temperatures between about 400° C. and 550° C. for about 90 minutes or more. In some embodiments, the method may also include, after operating the oven, detaching the sheet from the wall and wiping the wall.

FIG. 11 diagrammatically depicts an oven 110 having a cavity 16, and a sheet 112 sized to fit wall 14 of cavity 16 according to some embodiments of the present invention. Sheet 112 may have or may be embedded with a frequency selective surface 114 that may absorb energy selectively at a specified radio frequency range. Sheet 112 may include a metallic sheet with apertures 120′ sized, shaped and/or arranged to make sheet 112 selectively absorbing of energy of the specified radio frequency range. In some embodiments, this radio frequency range may comprise an ISM range, for example, the range between 2400 and 2500 MHz. Sheet 112 may be configured to be attached to wall 14. For example, sheet 112 may comprise magnets 116 that are sufficiently strong to prevent sheet 112 from separating from wall 14 during the cleaning operation. In some embodiments, sheet 112 may comprise adhesive patches 118 in addition to or instead of magnets 116. In some embodiments, oven 110 and sheet 112 may form together a kit 122. Kit 122 may also comprise instructions 120 how to attach sheet 112 to wall 14 and/or operate the oven 110 to supply RF energy to cavity 16 at the specified frequency range. Some embodiments may comprise a kit 122, comprising instructions 120 and sheet 112. Kit 122 may or may not include oven 110. Instructions 120 may also comprise instructions to detach sheet 112 from wall 14 and wipe the wall to clean it. In some embodiments, instructions 120 or a portion thereof may be provided on a barcode, RFID, or other machine readable element. For example, the instructions to operate oven 110 may be provided on a machine readable element, such that after reading the machine readable element, all that is required of a user in order to operate the oven at the specified frequency range is to press a “start” button.

In the foregoing Description of Exemplary Embodiments, various features are grouped together in a single embodiment for purposes of streamlining the disclosure. This method of disclosure is not to be interpreted as reflecting an intention that embodiments require more features than are expressly recited in each claim. Rather, as the following claims reflect, inventive aspects lie in less than all features of a single foregoing disclosed embodiment. Thus, the following claims are hereby incorporated into this Description of the Exemplary Embodiments, with each claim standing on its own as a separate embodiment.

Moreover, it will be apparent to those skilled in the art from consideration of the specification and practice of the present disclosure that various modifications and variations can be made to the disclosed systems and methods without departing from the scope of the claims. Thus, it is intended that the specification and examples be considered as exemplary only, with a true scope of the present disclosure being indicated by the following claims and their equivalents.

As used herein, the singular form “a”, “an” and “the” include plural references unless the context clearly dictates otherwise. The use of the terms “at least one”, “one or more”, or the like in some places is not to be construed as an indication to the reference to singular only in other places where singular form is used. In particular, throughout this specification, references are made to “object”, “an object”, or “the object” in singular. This term is used to refer to one or more objects, to an object comprising a plurality of objects, to a portion of an object, or the like.

The terms energy supply and energy application and their inflections are used herein interchangeably.

It is expected that during the life of a patent maturing from this application many relevant systems and methods will be developed and the scope of the terms dielectric heating unit, power supply, and feeds is intended to include all such new technologies a priori.

The terms “comprises”, “comprising”, “includes”, “including”, “having” and their conjugates mean “including but not limited to”. This term encompasses the terms “consisting of” and “consisting essentially of”.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

What is claimed is:

1. An apparatus comprising:
a casing having one or more walls and defining a cavity, wherein one of the one or more walls comprises a frequency selective surface (FSS) that selectively absorbs RF energy within a first frequency range;
a first RF feed configured to RF energy to the cavity within the first frequency range; and
a controller configured to control RF energy fed into the cavity via the first RF feed to heat at least a portion of the one of the one or more walls to a temperature above a specified lower temperature threshold for at least a specified period of time.

2. The apparatus of claim 1, wherein the specified lower temperature threshold is 400° C. or greater.

3. The apparatus of claim 1, wherein the FSS is located in the vicinity of the one or more walls.

4. The apparatus of claim 1, wherein the FSS is integral with the one or more walls.

5. The apparatus of claim 1, further comprising a heating unit configured to heat an object placed in the cavity.

6. The apparatus of claim 1, comprising an RF feed configured to supply RF energy within a second frequency range, the second frequency range being different from the first frequency range.

7. The apparatus of claim 6, wherein the first RF feed is configured to supply RF energy within the second frequency range.

8. The apparatus of claim 1, wherein the FSS is resonant at one or more frequencies within the first frequency range.

9. The apparatus of claim 6, wherein the FSS is not resonant with any of the frequencies within the second frequency range.

10. The apparatus of claim 6, wherein the second RF feed is configured to heat an object placed in the cavity.

11. An apparatus comprising:
a casing having one or more walls and defining a cavity;
a first heating unit configured to heat at least a portion of the one or more walls; and
a second heating unit for heating an object placed in the cavity, wherein the first heating unit is further configured to heat the at least one wall without significantly heating air in the cavity.

12. The apparatus of claim 11, wherein the first heating unit comprises:
a first RF feed, configured to feed the cavity with RF energy within a first frequency range; and
a frequency selective surface (FSS) resonant with one or more frequencies within the first frequency range.

13. The apparatus of claim 12, wherein the FSS is located in the vicinity of the one or more walls.

14. The apparatus of claim 12, wherein the FSS is integral with the one or more walls.

15. The apparatus of claim 11, wherein the first heating unit comprises a first RF feed that feeds the cavity with RF energy within a first frequency range and wherein the second heating unit comprises a second RF feed that feeds RF energy within a second frequency range, the second frequency range being different from the first frequency range.

16. The apparatus of claim 15, comprising a frequency selective surface (FSS) that is resonant with one or more frequencies within the first frequency range.

17. The apparatus of claim 15, comprising a frequency selective surface (FSS) that is not resonant at any of the frequencies included in the second frequency range.

18. An apparatus comprising:
a casing having at least one wall and defining a cavity;
an RF feeding system configured to feed RF energy to the cavity at two or more frequencies; and
a frequency selective surface (FSS) that is resonant with only one of said two frequencies or more.

19. The apparatus of claim 1, wherein the controller is configured to control RF energy supplied to the cavity based on information indicative of an amount of EM energy received from the cavity.

20. The apparatus of claim 11, further comprising a controller configured to control RF energy supplied to the cavity based on information indicative of an amount of EM energy received from the cavity.

21. The apparatus of claim 18, further comprising a controller configured to control RF energy supplied to the cavity based on information indicative of an amount of EM energy received from the cavity.

22. The apparatus of claim 11, wherein the first heating unit comprises:
a nozzle configured to spray an RF absorbing material on the one or more walls; and
an RF feed configured to feed RF energy to the cavity to heat the RF absorbing material on the one or more walls.

23. A method of operating a self-cleaning oven having a cavity, the method comprising:
receiving indication that self-cleaning is to be carried out;
in response to the indication that self-cleaning is to be carried out, feeding RF energy to the cavity at a frequency absorbed by a portion of a wall of the cavity; and
stopping RF energy feeding when or after the wall has been maintained between 400° C. and 550° C. for 60 minutes or more.

24. The method of claim 23, wherein the wall includes a frequency selective surface (FSS), and feeding RF energy comprises feeding energy at a resonance frequency of the FSS.

25. The method of claim 23, further comprising:
receiving an indication of an amount of EM energy received from the cavity; and
wherein the feeding RF energy to the cavity is performed in accordance with the indication of the amount of EM energy received from the cavity.
